(19) United States
(12) Patent Application Publication
(10) Pub. No.: US 2012/0019003 A1
(43) Pub. Date: Jan. 26, 2012

(54) Ocean Current-Based Hydroelectric Power Generation System

(76) Inventor: Ming Ying Hu, San Lorenzo, CA (US)

(21) Appl. No.: 12/840,236

(22) Filed: Jul. 20, 2010

(51) Int. Cl. F03B 13/18

(52) U.S. Cl. 290/53

(57) ABSTRACT

An ocean current-based hydroelectric power generation system is disclosed wherein the rotational assembly of the system floats at the surface of the water and comprises a paddle wheel style impeller with a plurality of paddles surrounding an axle wherein the paddles positioned above the surface of the water are propelled forward by the force of water current and wind. Each paddle is assembled with a pivotally attached blade to a pair of supporting members extending a distance from the surface of the axle, such that the blade pivots open while the paddle rotates underwater, allowing current to flow through it enabling continued rotation of the rotational assembly. The system further comprises of floatational devices positioned a distance from the rotational assembly as to prevent the tangling and crushing of seafaring creatures.

### BACKGROUND

1. Field of Invention

This invention relates to renewable energy-based power generation systems, avoiding pollution or greenhouse gas emissions. In particular, ocean current based hydroelectric power generation systems.

2. Background

Methods of deriving power from the sea include tidal powder, wave power, ocean thermal energy conversion, ocean winds, and salinity gradients. At present, the most developed methods of deriving power of these include tidal, wave, and thermal. The aim of systems that utilize the ocean waves and current to generate electrical power is to do so without the combustion of scarce, pollution-generating fossil fuel. In generating electrical power through the rapid and forceful rotation or movement of blades or other parts of current systems, many ocean current based power generation systems cause harm or death to seafaring creatures, such as fish or sea turtles that happen to come upon the current systems.

Accordingly, a need to for an ocean based hydroelectric power generation system that minimizes harm to seafaring creatures exists.

### SUMMARY

The apparatus in accordance with an embodiment of this invention is an ocean or water current based hydroelectric power generation system. The apparatus integrates a rotational assembly comprised of paddles that pivot around a transverse axle. Each paddle comprises of two support members that pivotally attach to a blade. The blade opens and closes, allowing water to flow through the paddle when the paddle is submerged and allowing water and wind to push against it, causing the rotation, when the paddle is above the water or sea line.

The apparatus rotates with forces transferred from the ocean current, the wind, or both. Floatational devices that keep the rotational portion of the apparatus afloat are positioned approximately two feet away from the edges of the rotating paddles. Due to the current controlled rotation of the system, seafaring creatures are easily deflected off the rotational portion (rotational assembly) of the apparatus. The distance between the rotational portion and the flotation devices of the system prevents sea life from becoming tangled and crushed, hence minimizing harm or death.

There is disclosed an apparatus for current-based hydroelectric power generation according to an embodiment of the present invention in which, the apparatus comprises an electrical generator, an anchor, an axle with a front end and a back end, and at least one paddle assembly. The paddle assembly further comprises of two support members and a blade, wherein each support member has a distal end and a proximal end. The proximal end is connected to the axle and the distal end is pivotally attached to a blade and the axle has the ability to rotate in a single direction, the direction of the water waves, utilizing the force of water waves applied to the blade.

There is further disclosed an apparatus for producing energy from water waves and wind comprising an electrical generator, an anchor, a plurality of paddle assemblies, where the paddle assembly further comprises two support members and a blade. Each support member has a distal end and a proximal end. The proximal end of the support member is connected to an axle and the distal end is pivotally attached to the blade, and an angle that opens between the support members and the blade is at most ninety degrees. Additionally, the axle rotates in a single direction.

These and other aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 is a front view of the current-based hydroelectric power generation system of FIG. 1, according to embodiment of the present invention.

FIG. 2 is a side cross sectional view of a current-based hydroelectric power generation device in accordance with an embodiment of the present invention

FIG. 3. is a side cross-sectional view of the current-based hydroelectric power generation device of FIG. 2 rotated in a 45 degree counterclockwise direction, according to an embodiment of the present invention.

FIG. 4 is an enlarged partial cross-sectional side view of a blade of the current-based hydroelectric power generation device according to an embodiment of the present invention.

FIG. 5 is a top view of the current-based hydroelectric power generation device of FIG. 1, according to embodiment of the present invention.

Reference Numerals

| | |
|---|---|
| 100 | the system |
| 101 | support member |
| 102 | blade |
| 103 | transverse axle |
| 104 | proximal end of a support member |
| 105 | distal end of a support member |
| 106 | hinge |
| 107 | rounded proximal end of a blade |
| 108 | pointed distal end of a blade |
| 110 | rotational assembly |
| 120 | floatational assembly |
| 121 | bearing assembly |
| 130 | power generator |
| 140 | anchor assembly |

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

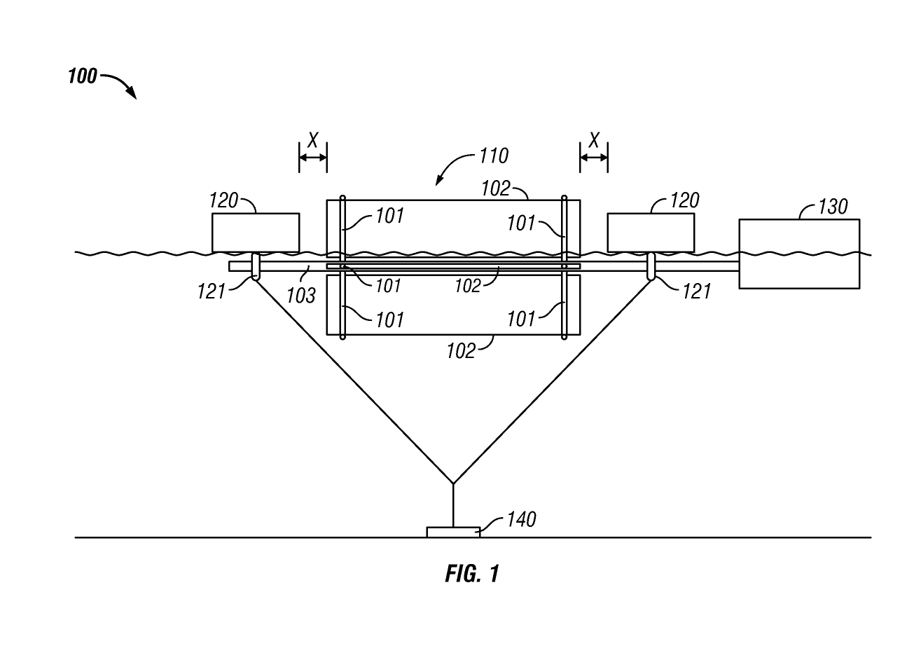

FIG. 1 is a front view of a current-based hydroelectric power generation system 100 in accordance with an embodiment of the present invention. Generally, the system 100 comprises a rotational assembly 110 connected to flotation assemblies 120 and a power generator 130. The rotational assembly 110 of the hydroelectric power generation system 100 rests at or slightly below sea level, staying afloat with the aid of two flotation assemblies 120. Forces from water current and wind, or water current alone facilitate the rotational movement of the rotational assembly 110. The direction of the rotational movement follows a single direction and may follow the direction of the wind. The system 100 is weighed down by the aid of an anchor 140.

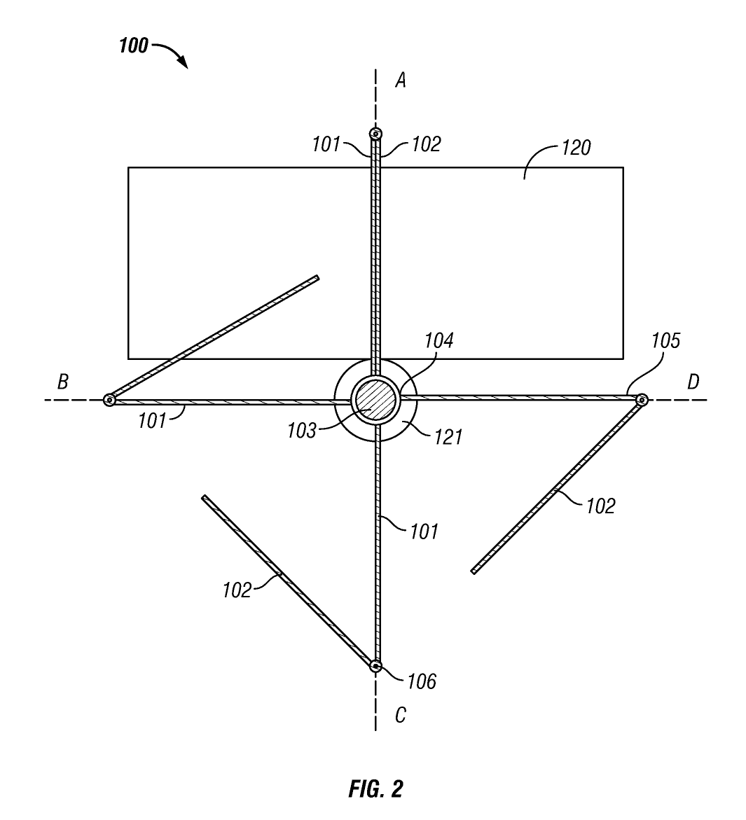

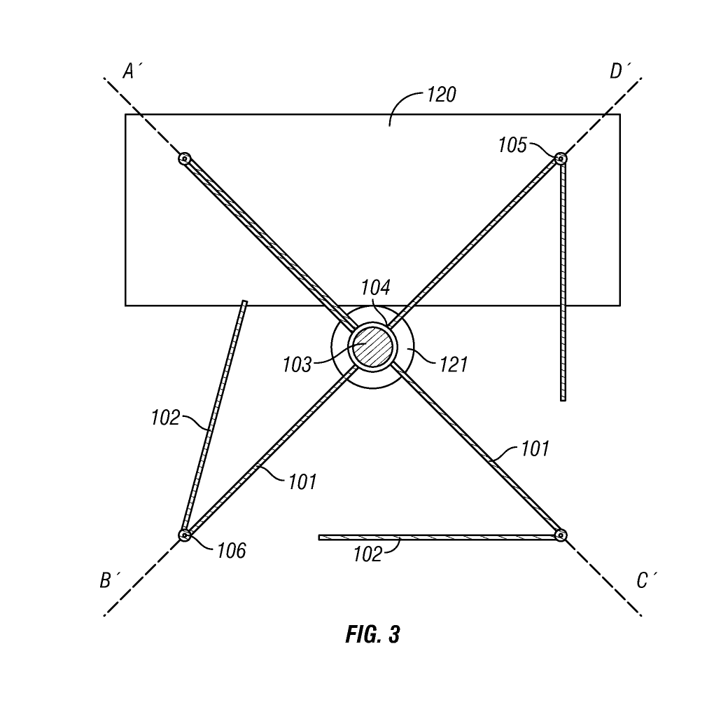

As depicted in the cross sectional side views of FIG. 2 and FIG. 3, an embodiment of the rotational assembly 110 of the current invention comprises a paddle wheel style impeller assembly that rotates around a transverse axle 103. The transverse axle 103 is a horizontal support frame that may be comprised of metal. The paddle wheel style impeller assembly may comprise of four paddle assemblies, as shown in FIG. 2 and FIG. 3. A preferred embodiment of the rotational assembly 110 comprises four paddle assemblies. In other embodiments, the invention may have at least three paddle assemblies or more than four paddles assemblies.

Each paddle assembly may comprise of a blade 102 and two support members 101 on each side of the blade 102. A blade 102 may extend from the right side of the transverse axle 103 to the left side of the transverse axle 103, as shown in FIG. 1. In an embodiment of the invention, a blade 102 is positioned on the rotational assembly 110 with two support members 101. The two support members 101 are disposed on opposite sides of the rotational assembly 110, the right side and the left side. As showed in FIG. 1, the blade 102 may extend the entire length of the rotational assembly 110.

As shown in FIGS. 2 and 3, the proximal end 104 of each support member 101 is affixed to the transverse axle 103. The distal, un-affixed end 105 of the support member 101 is pivotally attached to a blade 102. FIG. 3 illustrates a side cross-sectional view of the apparatus as shown in FIG. 2, at a rotation of approximately 45 degrees, according to an embodiment of the present invention.

In an embodiment of the invention, a blade 102 rotates around the distal end 105 of a support member 101 from 0 to at most 90 degrees, as shown in FIG. 2 and FIG. 3. The hinge 106 on the distal end 105 of the support member 101 may prevent the rotation of the blade 102 from exceeding a certain angle. Alternatively, the blade 102 rotation may be prevented from exceeding a certain angle by other means known in the art.

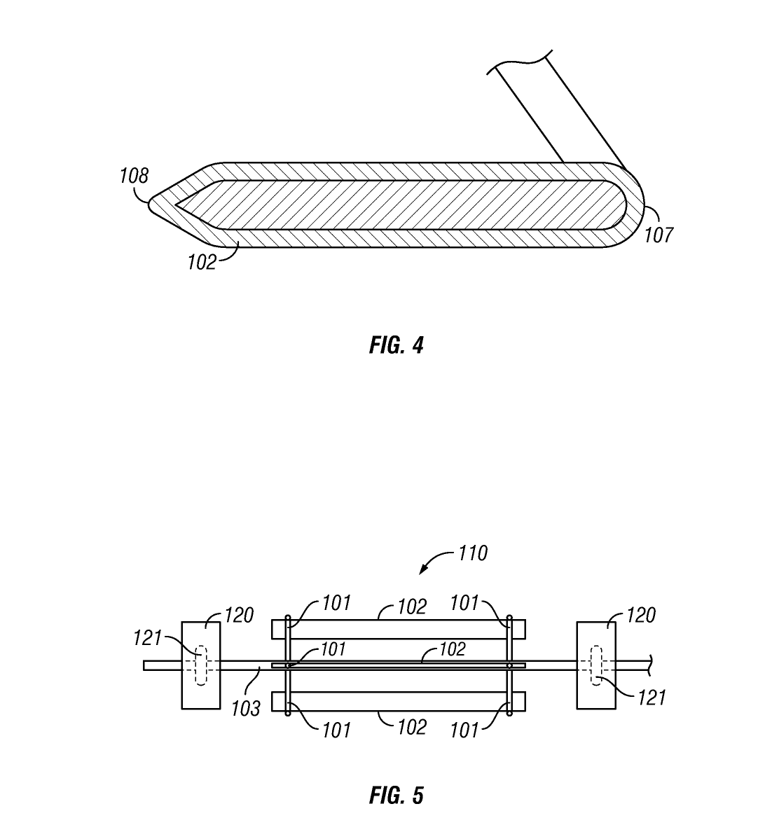

In an embodiment of the invention, the blade 102 may be shaped with a rounded proximal end 107 and a pointed distal end 108 as shown in the enlarged cross sectional view of FIG. 4. In this embodiment, a hinge (not shown) would connect the rounded proximal end 107 to the support members 101. The exterior portion of the blade is made of metal. The interior portion of the blade is comprised of a material such that the blade is ideally neither more nor less dense than the water the apparatus is floating on.

FIG. 2 illustrates a cross-section of a four paddle assembly apparatus showing one paddle assembly position at the highest point of rotation at position A; one paddle assembly at the lowest point of rotation at position C; and two paddle assemblies positioned at B and D, at approximately 90 degrees from A and C respectively.

In an embodiment of the invention, as depicted in FIG. 2, the blade 102 of the paddle assembly positioned at A is collapsed or folded onto the right side of the support member 101 such that it is parallel to the support member 101. The angle between the support member 101 and the blade 102 is zero degrees. In this position, the water current flows onto the collapsed blade 102, pushing the paddle to the right and causing the rotational assembly 110 to rotate in a counter clockwise direction, as shown in FIG. 3.

As shown in FIG. 3, the paddle assembly previously positioned at A in FIG. 2 would be positioned at position A′ after a 45 degree counter-clockwise rotation. Similarly, the paddle assembly previously positioned at B in FIG. 2 would be positioned at position B′; the paddle assembly previously positioned at C would be positioned at position C′; and the paddle assembly previously positioned at D would be positioned at position D′.

As the paddle assembly at position A rotates in a counterclockwise direction, it falls onto the water surface at approximately position B, as shown in FIG. 2. When the paddle assembly reaches the surface of the water, the blade 102 is pushed open by the surface tension of the water. As the paddle assembly continues to rotate downward, from positions B to B′, the blade 102 continues to open allowing water to flow through the open space between the axle 103 and the support members 101. In an embodiment of the invention, at the lowest point of a paddle assembly's rotation at position C, the blade 102 is in its most open position, but opened no more than 90 degrees from the support members 101.

As the paddle assembly continues to rotate in a counterclockwise direction, the blade 102 continues to allow water to flow through the space opened by the blade 102. The paddle assembly exits the water, moving from position C′ to D to D′, as shown in FIG. 2 and FIG. 3. After the paddle assembly exits the water at approximately position D, the blade 102 collapses onto the support members 101 from the force of gravity. The rotation of the paddle assembly back to position A closes the angle between the blade 102 and the support members 101, as shown in FIG. 2. The rotation of the paddle assembly occurs through the wave/current motion and may be facilitated by wind.

In an embodiment of the invention, the rotational assembly 110 is kept afloat on or near the surface of the water by two flotation assemblies 120, as shown in FIG. 1. The floatational assemblies 120 may be, for example, buoyant ocean platforms. The floatation assemblies 120 keep the transverse axle 103 afloat at or just under the water surface.

As shown in FIG. 1, a floatational assembly 120 may be attached to both the right side and the left side of the rotational assembly 110. In an embodiment of the invention, each floatational assembly 120 is kept at a distance X, for protecting against potential entanglement of seafaring creatures. For example, distance X is of approximately two feet from an edge of the rotational assembly 110, or from a point where a support member 101 extends from the axle 103. The two feet distance between the rotational assembly 110 and the floatational assembly 120 provides an avenue of escape for seafaring creatures, preventing the death or injury of any sea creatures that happen upon the apparatus.

In an embodiment of the invention, a bearing assembly 121 comprising of a bearing attached to the floatational assembly 120 to the transverse axle 103, as shown in FIG. 1. In another embodiment of the invention, the bearing assembly 121 comprises a bearing that attaches to the floatational assembly 120 using a metal clamp and attachment means such as screws/bolts. The screws secure the floatational assembly 120 to the metal clamp. According to another embodiment, the bearing assembly 121 comprises a bearing that is attached to the floatational assembly 120 through an intermediary structure such that the floatational assembly 120 is not in direct contact with the bearing.

A power generator 130 is connected to the side of the rotational assembly 110, as shown in FIG. 1. The transverse axle 103 is operatively connected to a generator 130 either under the water or above the water surface. The generator 130 has the means and is assembled such that it floats in the water, as shown in FIG. 1. As illustrated in FIG. 5, each floatational assembly 110 is positioned on top of each bearing assembly 121. FIG. 5 illustrates the top view for the apparatus, with the axle 103 extending on the right side of indeterminate length. The electrical/power generator 130 is operatively connected to the axle 103 on either side of the apparatus. The generator 130 may further be connected and located on shore.

According to an embodiment of the invention, the system 100 is weighted in place by an anchor assembly 140 that may be attached to the bearing assemblies 121, as shown in FIG. 1. In an embodiment of the invention, the anchor assembly 140 is a flat board-like apparatus that rests on the seabed with rocks and other items used to weigh it down. In an embodiment of the invention, the anchor assembly 140 is attached to the bearing assemblies 121 via an anchor line in a “Y” formation, as shown in FIG. 1. In another embodiment of the invention, the anchor assembly 140 is attached to the apparatus with a line in a “V” formation. The anchor 140 is attached to the apparatus using a line of wire, or cable or other material known in the art.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

I claim:

1. An apparatus for producing energy from water waves comprising:
a floating rotational assembly having
an axle with a right side and a left side; and
three or more paddle assemblies, each paddle assembly comprising two support members spaced a distance apart along the axle and each extending radially from a surface of the axle, and a blade spanning at least the distance between the support members and pivotally attached to a distal end of each support member;
wherein said axle rotates in a single direction by the force of the water waves against the blade of each paddle assembly;
a first bearing assembly mounted over the right side of the axle that extends beyond the right side of the rotational assembly;
a second bearing assembly mounted over the left side of the axle that extends beyond the left side of the rotational assembly;
an anchor connected to a line attached to each of the first and second bearing assemblies; and
an electrical generator driven by rotation of the paddle assemblies.

2. The apparatus of claim 1, wherein there are least four paddle assemblies.

3. The apparatus of claim 1, wherein the blade further comprises a proximal end pivotally attached to the support member and a distal end, wherein a side profile of the blade has a rounded shape at the proximal end tapering to a point at the distal end.

4. The apparatus of claim 1, wherein an angle that opens between the blade and the support members is at most ninety degrees.

5. The apparatus of claim 4, wherein the blade at its highest point of rotation, is collapsed onto and parallel to the support members and the angle is zero degrees.

6. The apparatus of claim 1, wherein the anchor is a flat board that is further weighted down by placing objects on a top of the flat board.

7. The apparatus of claim 6, wherein the anchor is connected to the first and second bearing assemblies by the line in a Y shaped formation.

8. The apparatus of claim 1, further comprising at least two flotation devices, one flotation device connected to the first bearing assembly and a second flotation device connected to the second bearing assembly.

9. The apparatus of claim 1, wherein the electrical generator is connected to the axle and floats.

10. The apparatus of claim 8, wherein a proximal end of each support member is connected to the axle and each flotation device is positioned at least two feet away from an outer edge of a connection of the support member to the axle.

11. An apparatus for producing energy from water waves and wind comprising:
a rotational assembly having
an axle with a right side and a left side; and
at least four paddle assemblies, each paddle assembly comprising two support members spaced a distance apart along each side of the axle, each support member having a proximal end and a distal end, and each extending radially from the surface of the axle, and a blade covering the distance between the support members and pivotally attached to a distal end of each support member;
wherein said axle rotates in a single direction by the force of the water waves against the blade of each assembly;
a first bearing assembly positioned on the right side of the axle extending beyond the rotational assembly;
a second bearing assembly positioned on the left side of the axle that extends beyond the left side of the rotational assembly;
a first floatational assembly connected to the first bearing assembly;
a second floatational assembly connected to the second bearing assembly;
an anchor connected to a line attached to each of the first and second bearing assemblies; and
an electrical generator driven by rotation of the paddle assemblies.

12. The apparatus of claim 11, wherein the first bearing assembly mounted with a first metal clamp for connection with the first floatational assembly and a second bearing assembly mounted with a second metal clamp mounted for connection with the second floatation assembly.

13. The apparatus of claim 12, wherein the first metal clamp and second metal clamp are connected by a screw connection to the first floatational assembly and second floatation assembly respectively.

14. The apparatus of claim 11, wherein the blade further comprises a proximal end pivotally attached to the support member and a distal end, wherein a side profile of the blade has a rounded shape at the proximal end tapering to a point at the distal end.

15. The apparatus of claim 14, wherein water flows through an opening formed by an angle that opens between the blade and the support members as the paddle assemblies are submerged under water.

16. The apparatus of claim 15, wherein the blade of the paddle assembly at its highest point of rotation, is collapsed onto and parallel to the support members and the angle is zero degrees.

17. The apparatus of claim 11, wherein the anchor is a flat board that is further weighted down by placing objects on a top of the board.

18. The apparatus of claim 11, wherein the anchor is connected to the first bearing assembly and the second bearing assembly with the line in a Y formation.

19. The apparatus of claim 11, wherein the anchor is connected to the first bearing assembly and the second bearing assembly by the line in a V formation.

20. The apparatus of claim 11, wherein the proximal end of each support member is connected to the axle, and the first floatation assembly and the second flotation assembly is positioned at least two feet away from an outer edge of a point at which the support member extends from the axle.
